(19) United States
(12) Patent Application Publication
(10) Pub. No.: US 2016/0029052 A1
(43) Pub. Date: Jan. 28, 2016

(54) Method And Apparatus For Converting Audio, Video And Control Signals

(71) Applicant: BRITISH BROADCASTING CORPORATION, London (GB)

(72) Inventors: Nicholas PINKS, Wimbledon, London (GB); James WEAVER, Greater Manchester (GB); Justin MITCHELL, West Sussex (GB); Martin THORP, South Croydon (GB)

(21) Appl. No.: 14/377,697

(22) PCT Filed: Feb. 11, 2013
(86) PCT No.: PCT/GB2013/000054

§ 371 Date: Aug. 8, 2014

(30) Foreign Application Priority Data
Feb. 10, 2012 (GB) 1202472.5

(51) Int. Cl. H04N 21/2343; H04N 21/2385; H04N 21/434; H04N 21/4223; H04N 21/643; H04N 21/6437; H04N 21/2381; H04N 21/233; H04N 21/242

(52) U.S. Cl. CPC H04N 21/234309; H04N 21/2335; H04N 21/2385; H04N 21/4346; H04N 21/242; H04N 21/64322; H04N 21/6437; H04N 21/2381; H04N 21/4223

(57) ABSTRACT

An apparatus for converting between synchronous audio, video and control signals and asynchronous data streams for an IP network as interfaces for the audio and video signals and for control signals. A processor is arranged to convert between the synchronous audio, video and control signals and asynchronous packaged data streams. The data streams are sent on a stream according to IP standards that are selected according to the nature of the signal to be transmitted.

### BACKGROUND OF THE INVENTION

This invention relates to conversion and transmission of audio-video and control signals between cameras and studio equipment.

### SUMMARY OF THE INVENTION

The improvements of the present invention are defined in the independent claims below, to which reference may now be made. Advantageous features are set forth in the dependent claims.

The present invention provides an encoding/decoding method, an encoder/decoder and transmitter or receiver. The invention also provides a device that may be provided as an addition to a camera or to studio equipment.

In broad terms, the invention provides a device that converts signals used in a broadcast environment from multiple existing standards to Internet Protocol (IP) and also from IP to such existing standards. The IP signal provides broadcast quality of audio video signals as well as signalling required in a studio environment. The signalling required in the studio environment may be referred to as “control” signalling, in the sense that it controls devices and displays, such as providing information to studio operators, or to control equipment. Such control signals include indications such as which camera is live, where to move a camera and so on.

In particular, the invention provides apparatus for converting between synchronous audio, video and control signals and asynchronous packaged data streams for an IP network, comprising: a first interface for audio and video signals; a second interface for control signals; and a processor arranged to convert between synchronous audio, video and control signals and asynchronous packaged data streams, wherein each packaged data stream is according to one of multiple IP standards, each standard being selected according to the nature of the signal to be transmitted. This has the advantage that the nature of the signal (e.g. whether audio, video, control or type of control) may be used to determine the type of IP standard used for that signal.

The apparatus is bidirectional in the sense that the packaged data streams are sent and received over an IP network and then converted to and from IP standards to synchronous audio, video and control signals. The IP streams are thus for an IP network in the sense that they may be transmitted or received over such a network.

Preferably, the standard selected is the lowest bandwidth such standard for the selected signal. Preferably, a lower bandwidth protocol is used for the control signals than the audio video signals.

Preferably, the audio and video are converted to RTP. This has the advantage of a being packet format which enables reliable transmission and guarantees order of delivery as well as potential for forward error correction.

Preferably, the control signals are converted to UDP. This allows the most efficient packetisation giving appropriate speed of delivery, and lower bandwidth than RTP. Preferably, the protocols are as set out in the table at FIG. 4 herein.

Preferably, the apparatus includes a processor for receiving control signals in an IP standard and for asserting a control output at a camera.

The control output is preferably a tally visual or audio indicator, such as a tally light or a sound generated in operator's headphone. The control output is preferably a camera control signal, such as RS232, RS422, LANG or similar for controlling aspects of a camera, such as focus, zoom, white balance and so on. The control output is preferably a talkback signal, namely a bidirectional audio feed between camera operator and a controller.

Preferably, the apparatus comprises an input arranged to receive the multiple IP video streams over the IP network from other camera sources and a processor arranged to output video for presentation to a camera operator. The apparatus includes switching to allow a camera operator to switch between these video streams.

Preferably, the apparatus comprises a device connectable to a video camera having connections to the interfaces, typically in the form of a separate box with attachment to the camera. In such a device, the processor is arranged to convert from native audio-video signals of the camera to asynchronous packaged data streams for transmission to studio equipment. The processor is also arranged to convert control signals from asynchronous packaged data streams received from studio equipment to native signalling required by the camera or by ancillary devices coupled to the camera, such as tally lights, headphones or the like.

Preferably, the apparatus comprises a device connectable to studio equipment. In such a device, the processor is arranged to convert from asynchronous packaged data streams received from cameras to native audio-video signals required by the studio equipment. The processor is also arranged to convert control signals from the studio equipment to asynchronous packaged data streams for transmission to one or more cameras.

Preferably, a single device is connectable to either a camera or to studio equipment to provide the appropriate conversion.

The invention may also be delivered by way of a method of operating any of the functionality described above, and as a system incorporating multiple cameras, studio equipment and apparatus as described above.

### BRIEF DESCRIPTION OF THE DRAWINGS

An embodiment of the invention will be described in more detail by way of example with reference to the accompanying drawings, in which:

FIG. 1 is a an image of a device embodying the invention;

FIG. 2 is a block diagram of the main components of the device of FIG. 1;

FIG. 3 is a table showing the preferred protocols as used in a device embodying the invention;

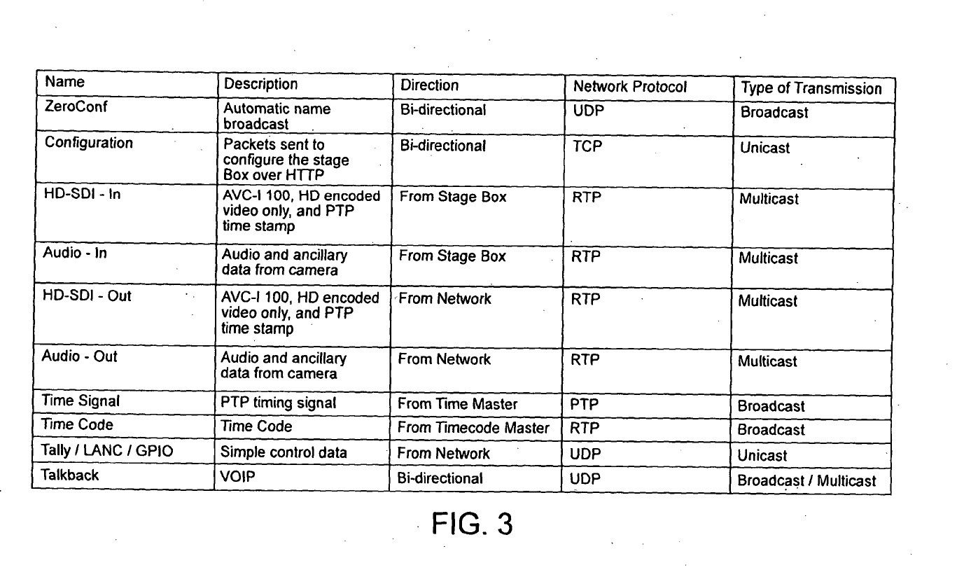

FIG. 4 is a block diagram showing the main hardware components of a device embodying the invention; and

FIG. 5. shows a process diagram for a controller algorithm.

### DETAILED DESCRIPTION OF A PREFERRED EMBODIMENT OF THE INVENTION

### Summary

### General

An embodiment of the invention comprises a device that is connectable to a camera to provide conversion from signalling required by the camera to (P data streams and from IP data streams to signalling for the camera. The same device may also be used at studio equipment for converting IP streams received from cameras for use by the studio equipment. As such a single type of device may be deployed at existing items of television production equipment such that transmission between devices may use IP.

An advantage of an embodiment of the invention is that it allows camera equipment of the type used in a studio environment or remotely but in conjunction with a production facility to take advantage of transmission of data to and from the device over packet based networks. Such a system may include multiple cameras, studio equipment and potentially one or more central servers for control, each with a device embodying the invention.

The embodiment may additionally provide functionality for example coders converting will be automatically set depending upon connectivity factors such as how many cameras are detected in the system, what editing system is used and so on. The server within a system can send instructions back to each device to change various settings using return packets. The cameras may be anywhere in the world and the instructions may include corrective information or other control data such as a “tally light”.

The device may be implemented as an integral part to future cameras and studio equipment. The main embodiment that will be described, though, is a separate device that may be used as an add-on to existing equipment such as cameras, mixing desks and other studio equipment: We will refer to such a device herein as a “Stage Box”, as described in the following technical note description.

### Timing

We have appreciated the need to consider timing information when converting between synchronous devices such as cameras and an asynchronous network such as an IP network. In one example, a camera may be attached to a so called “stage box” for conversion of its output to an IP stream, and a remote control remote from the camera may be attached to a second such stage box for converting between IP and control signals. Each of the camera and the remote control need to be unaware of the intermediary IP network and to send and receive appropriate timing signals in the manner of a synchronous network, although the intermediary is an synchronous open standard IP network. More generally, each device attached to an IP network requires functionality to provide timing. For this purpose a timing arrangement is provided.

The timing arrangement comprises use of a timestamp in a field within IP packets sent from each device, the timestamp being derived from a local clock within each device. The timestamps within the packets received by each device are then processed according to a function and used relative to a local clock to ensure each device has a common concept of time, in particular a lock on frequency and preferably also a lock of phase. In the embodiment, the function includes deriving network latency and setting a local time accordingly. The function includes controlling the local clock for frequency and/or phase. The majority of IP packets are RTP. RTP is used to transport video and audio data from one box to another. The RTP packets are timestamped using a clock which is being synchronised via PTP. PTP is used to synchronise the clocks between multiple devices, and to establish a choice of best master.

The timing functionality may also include a smoothing function to ensure that any packets arriving do not cause any sudden changes in comparison to the local clock.

The timing arrangement may also include functionality within each device to determine whether it should act as a master clock to other devices, or as a slave to other devices. Using this functionality, a network of such devices may self organise when connecting to an IP network.

### Introduction/Overview

Traditional production systems rely on SDI (Serial Digital Interface) routing—that is point to point synchronous distribution. This can be demonstrated, in the most simple production system by connecting a camera directly to a monitor. The professional standard between these two devices is SDI. The Stage Box is a marked departure from the broadcast standards of SDI, to IT infrastructure standards of IP (Internet Protocol), more specifically RTP (Real Time Protocol). The drive for this change is cost. IT infrastructure costs are significantly lower than that of specialised Broadcast equipment. The industry is seeing this change already, in the large enterprise distribution (between broadcast centres, nationally and globally.)

There are a series of different IP encoders and decoders (erroneously known as codecs) available on the market. These often use proprietary network protocols to ensure correct sending and receive. The Stage Box builds on the concept of sending and receiving video and audio across broadcast centres, and looks at the tools required by camera operators and in studios. Based lower down the ‘food chain’, the Stage Box aims to commodities IT equipment and standards in the professional broadcast arena.

This is achieved by analysing standard methods of work for all the main genres (News, Sport, Long-form Entertainment, Live Studio Entertainment, and Single Camera Shoots) and looking at the ‘tools’ required across these genres. Once the ‘tools’ have been defined, the Stage Box has been designed, to allow easy access to these ‘tools’ over IT infrastructure.

In addition to the technical challenges described, a primary aim of the Stage Box, is to produce an open-standard device, where possible using the Industry IT standards. This will allow further integration in the future to what-ever the industry may develop.

After reviewing many productions, a common set of requirements have been identified, they are as follows:

Full HD Video support (1920×1080 4:2:2 25 fps Interlaced) as a minimum.

Defined as SMPTE standard 292M

Analogue Audio In and Out

Ease of configuration

Talk-back (no defined standard)

Deck Control

Serial data over RS232 and RS422

Camera Control (no defined standard)

Sony IANC (no defined standard)

Tally (no defined standard)

The embodiment is arranged to change these broadcast standards, into an IP stream, in a single device over common IP standards. The methods of achieving this have been described through out this technical note.

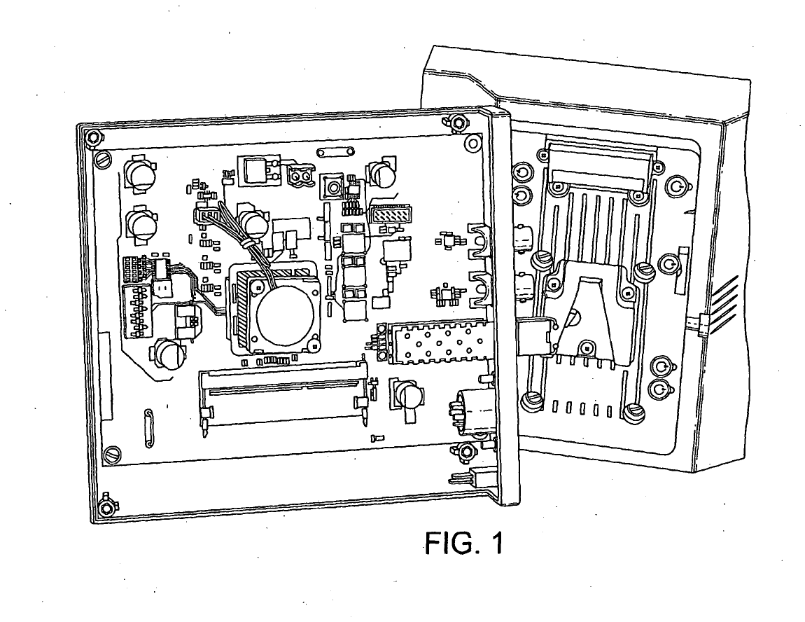

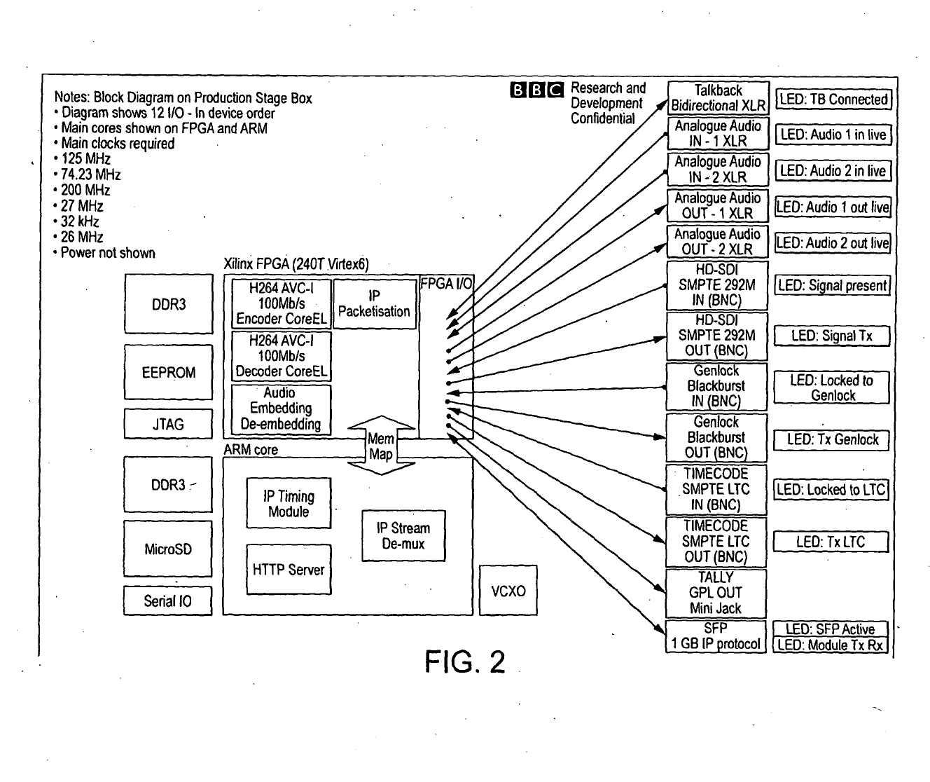

FIG. 1 shows an example of a device embodying the invention, the so called “Stage Box”. The main interfaces can be seen, gold BNC connectors for the video in and out (HD SDI), and the long silver SFP cage for the network adaptor. The block diagram of FIG. 2 shows the different interfaces included in the design. It also shows the core processor elements.

The Stage Box technical design is based around a Field Programmable Gate Array (FPGA), which has two main roles, the first, a supervisory role. The diagram shows how all the different interfaces are routed by the FPGA to the different functional blocks. Its second role is to provide the real-time video encoder and decoder.

The blocks on the left of the diagram are all resources available to either the FPGA, or the ARM processor, for example DDR3 memory.

The all-encompassing idea for the Stage Box is to take the many different production formats and move them from traditional linear signals to a single, bidirectional data feed over standardised Internet Protocols (IP), running on an Ethernet layer two network. With this in mind, the Ethernet component is arguably the most intrinsic part of the Stage Box, and it is here we find the greatest challenges. Similar to traditional multiplexing, IP signals can contain any number of discrete data lines, however the big difference is that the traffic can ‘flow’ in-both directions.

There is also a problem, though we know by the very nature of progression in technology that it will soon be mitigated; IP infrastructures have a very limited bandwidth, which is significantly less that that of uncompressed HD.

Essential to the development of the Industry's IP capability, is the ability to use common IT networking standards. The Stage Box embraces this concept and uses the following IP protocols:
Real Time Media Protocol (RTP) and its corresponding control protocol (RTSP)
User Datagram Protocol (UDP)
Transmission Control Protocol (TCP)
Precision Time Protocol (PTP)

These different protocols are the methods and descriptions by which the media is packaged. This takes place in two parts of the system, the ARM processor is running a web server, which needs to be able to correctly understand TCP and HTTP protocols, while the FPGA is handling the media, and so is required to generate and decode RTP and UDP streams. The FPGA, as previously mentioned routes the streams to the correct destination.

The final part of the Ethernet block, is the physical layer. To enable the most flexible solution, the Stage Box is supporting the use of Small Form Protocol blocks, SFPs. These are a physical cage in which the user manually fits a module either for a standard networking cable (RJ45 CAT 5e) or a fibre optic link.

HO-SDI In and Out

HD-SDI is defined by SMPTE 292M, and contains three main elements, video, audio and ancillary data. The Stage Box fully supports the standard with regards to it's different frame rates, and resolutions for video. The Stage Box also handles it's main elements. The diagram at FIG. 2 shows how HD-SDI enters the Stage Box, and is converted to IP.

Note: SDI is a digital signal, and so the A to D process is handled outside of the Stage Box.
Process 1—The SDI is received and split into its constituent parts, the audio and ancillary data are stored in RAM, for retrieval later.
Process 2—The video is encoded to AVC-I 100
Process 3—as the encoding is achieved; the resultant stream is packaged and along with the audio and ancillary data is made ready for transmission over the IP protocol.

An addition to the above description there is the added facility offered by the Stage Box of adding analogue audio to the stream. This has two main requirements:

Analogue to Digital process. (*MHz, 24 Bit)

Select the HD-SDI audio channels the audio is to be added to,

Once these have been satisfied, the audio is added to the RAM as before, and the pulled out (FIFO buffer process) by the FPGA as required by the IP packager.

For the return signal, the following process is achieved:
Process 1—IP Stream received by MAC
Process 2—De-mux of Video, Audio, Ancillary Data, Tally, and other streams.
Process 3—Audio and Ancillary Data added to RAM, while with the exception of video, the other streams are sent to the ARM core.
Process 4—Video is sent to AVC-I Decoder
Process 5—HD-SDI synchroniser pulls the audio, video and ancillary data as required.

Audio

Audio is an important part of any production, and is used technically in many different ways. The Stage Box supports the two of the most common methods;

Digitally, embedded in the HD-SDI stream

As an analogue signal ‘broken’ out of the HD-SDI stream

HD-SDI carries 16 discrete audio channels as part of its signal, and the Stage Box correctly handles this. This requires some delaying of the audio, to compensate for the video encoding delay and still ensure synchronised video and audio, when they are both packaged for the IP stream.

The extra addition of analogue audio break-out gives productions an incredibly useful feature, in that additional microphones can be added at will to a soundscape, or can be used for monitoring (receiving programme audio down the line).

Having analogue audio presents a series of technical challenges, as professional broadcast audio requires a large amount of headroom, relatively high voltage, and is very sensitive to electromagnetic interface on printed circuit boards (PCB) with fast data transmissions. The interference has been mitigated in the Stage Box, by having a separate PCB for the audio.

As the analogue audio is a ‘break out’, or an ‘add in’ to the HO-SDI signal, and there are only two inputs and two outputs on the Stage Box, the Stage Box needs to be configurable (patchable). Patching is achieved through the web interface, managed on the ARM processor.

Talkback

In production environments there is a need for a reliable method of communication between the different members of the production team. This is achieved through talkback. The Stage Box includes a talkback stream, over IP-, which is in effect a common VOIP (Voice Over IP) application. This has the added benefit of being easily supported by IT professionals.

In addition to the VOIP application, the Stage Box also has Bluetooth capabilities, and will stream the talkback over Bluetooth, thus giving the production teams, wireless talkback with out any additional equipment or cost, to that of the Stage Box.

This is achieved, by using the ARM processor to run a VOIP stack, and stream it's output to a Bluetooth chip, which in turn transmits the ad-hoc network signal (VOIP) to the headset. Obviously being a talkback system, the VOIP needs to be bi-directional, i.e. a microphone signal needs to be sent from the Stage Box.

Tally

A relatively old tool used in productions, the Tally is a simple fight that is triggered in multi-camera shoots when the vision mixer has selected a specific camera. I.E. Camera 1's Tally will light, when the vision mixer has selected Camera 1 to go live. Floor Managers, and On Screen Talent often use this in order to know which camera to look at.

The information is easily sent over IP, and is decoded by a simple application running on the ARM core. The application will also generate an audio signal over the talkback system for the operator.

Wifi

The Stage Box can also provide an IP video stream, at low bitrate, over Will for remote monitoring via a simple web interface. This will be based around HTML5 and will be supported by all the major browers.

Configuration of the Stage Box is possible over Wifi, as the configuration web page is served to all HTTP requests, and the Wifi chip within the Stage Box, is set to work as an Ad-hoc network point.

AVC-I 100

As discussed earlier, there are limitations of using IT networking infrastructures; the main being a limited bandwidth less than that of uncompressed HD. HO-SDI has a bitrate of ˜1500 Mb/s as opposed to most networks maximum bitrate of 1000 Mb/s. As a production is likely to have multiple cameras on a single network, the maximum realistic bitrate one could network is 100 Mb/s.

H.264 High Level encoding, or Advanced Video Coding (AVC) as it's known has a specific sub-standard; AVC-I 100, which is a very rigid encoding profile, that limits the bandwidth to 100 Mb/s.

The Stage Box is using an AVC-I encoder and decoder developed by CoreEL, an Indian hardware manufacturer. This allows the Stage Box to be designed and developed around a coding block, but never to develop a specific encoder its self—as over time standards will change.

ZeroConf

ZeroConf is a networking protocol, which allows a network device to automatically announce itself on a network and get the necessary IP details to work alongside other devices with out manual configuration. It achieves this by using Multicast Domain Name Services (mDNS). mDNS is a very useful tool, which is widely used by Apple, called their Bonjour system.

The Stage Box implements an open-source version of ZeroConf on the ARM hardware, which allows automatic configuration of the device's IP settings. It is also used for the recorder and control application to run the ‘Workflow Toolset’, a suit of tools, which allow the user to dynamically draw the production network as they see fit.

### Timing Information

We have appreciated that there are problems regarding timing information when data is exchanged in an asynchronous network. Studio equipment receiving AV feeds from multiple cameras needs a mechanism to switch between those cameras. However, data transmitted over an IP network from cameras is not guaranteed to arrive in any particular order or in a known time interval. In the absence of proper timing information, the studio equipment accordingly cannot reliably process packet streams or switch between different packets streams. A device embodying the invention incorporates a new arrangement for providing timing.

As previously described, the “Stagebox” device can operate as an SDI to IP and IP to SDI bridge on a local network, and may be used as part of the wider IP Studio environment. This disclosure describes concepts addressing the problems of timing synchronisation in an IP network environment. In this arrangement, AV material is captured, translated into an on-the-wire format, and then transmitted to receiving device, which then translates it back to the original format. In a traditional synchronous environment, the media data arrive with the same timing relationship as they are sent, so the signals themselves effectively carry their own timing. When using an asynchronous communication medium, especially a shared medium such as ethernet, this is not possible, and so the original material must be reconstructed at the far end using a local source of timing, such as a local oscillator or a genlock signal distributed via a traditional cable set up. In addition the original source for each piece of content needs to be timed based on some sort of source, such as a local oscillator or a genlock signal. In a traditional studio this is solved by creating a genlock signal at a single location and sending it to all the sources of content via a traditional cable system. In the (P world we need a different mechanism for providing a common sense of synchronisation.

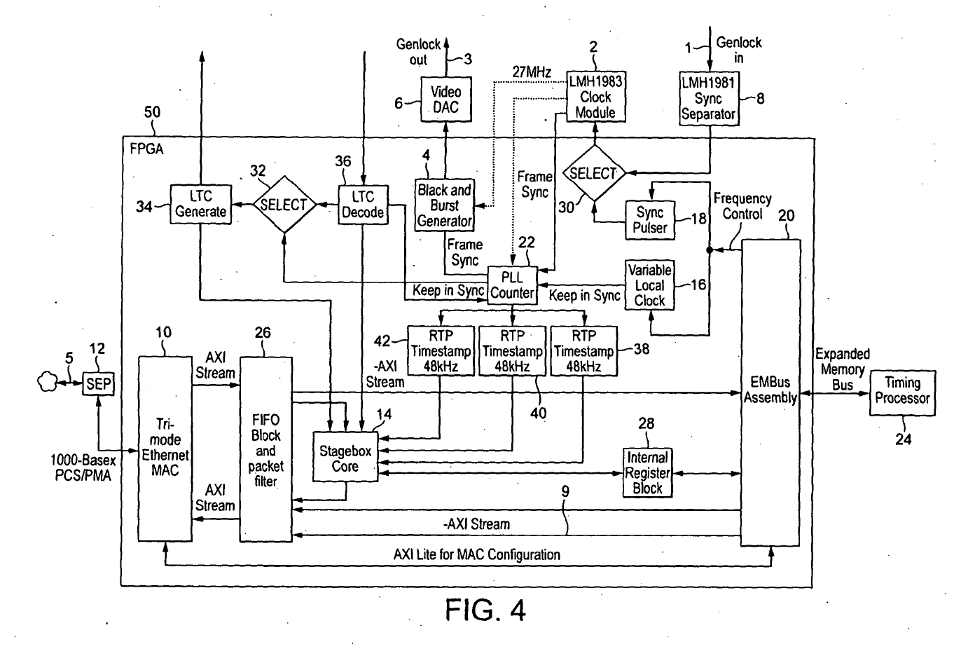

Since the ethernet medium does not provide a guaranteed fixed latency for particular connections a system making use of it must be able to cope with packets of data arriving at irregular intervals. In extreme cases packets may even arrive in an incorrect order due to having been reordered during transit or passed through different routes. Accordingly, any point-to-point IP Audio-visual (AV) link the receiving end must employ a buffer of data which is written to as data arrive and read from at a fixed frequency for content output. The transmitter will transmit data at a fixed frequency, and except in cases of extreme network congestion the frequency at which the data arrives will, when averaged out over time, be equal to the frequency at which the transmitter sends it. If the frequency at which the receiver processes the data is not the same as the frequency at which it arrives then the receive buffer will either start to fill faster than it is emptied or empty faster than it is filled. If, over time, the rate of reception averages out to be the same as the rate of processing at the receive end then this will be a temporary effect, if the two frequencies are notably different, however, then the buffer will eventually either empty entirely or overflow, causing disruptions in the stream of media. To avoid this, a mechanism is needed to keep the oscillators running on the transmitter and the receiver synchronised to each other. For this purpose, a new arrangement is provided as shown in FIG. 4.

FIG. 4 shows a simplified version of the timing, networking, and control subsystems of the stagebox circuitry. For clarity this diagram shows the connections necessary for understanding the functionality and leaves off various further connections that may be provided. The diagram also omits the existence of an additional counter, the “Fixed Local Clock” (FLC) which runs from 125 MHz ethernet oscillator, and as such is unaffected by any changes made to the frequency of a 27 MHz crystal oscillator.

The function performed by the arrangement of FIG. 4 is to provide a local clock that is in frequency lock with a clock provided by a network source (which may be another “stagebox”) and is preferably also in phase lock with such a network clock. The frequency lock is provided for reasons discussed above in relation to rate of arrival and buffering of packets. The phase lock allows devices to switch between multiple different such sources without suffering sequencing problems.

The arrangement comprises a main module in the form of an FPGA 50 arranged to receive and send packets from and to a network 5, and a timing processor or module 24 coupled to the FPGA and having logic to control the provision of local clock signals in relation to received packets. The timing processor 24 implements functionality later referred to as a PTP stack under control of a software module referred to as a PTP daemon. This receives packets and implements routines to determine how to control local clocks to ensure frequency and phase lock.

The functionality of the FPGA 50 will be described first. IP packets are sent to and received from network 5 via a tri-mode ethernet block 10 and a FIFO buffer 26. The packets are provided to and from the ARM processor, via a communication module here shown as EMBus 20 that provides the packets to other units within the main module 50, but also to the timing processor 24 A problem, as already noted, is to ensure that the local device to which the circuit is connected (or within which it is embedded) operates at a frequency locked with the frequency with which packets were sent such that the FIFO 26 neither empties nor overflows. For this reason, a Genlock output 3 is arranged so that it is frequency locked to a local clock which may be driven by a local input, allowed to run free, or driven to match a remote clock.

The local frequency lock will be described first. A clock module, here LMH1983 clock module 2, is provided having a 27 MHz output. This is provided to a black and burst generator 4 which feeds a DAC 6 to provide a genlock out signal to a camera. The input to the clock module 2 takes the form of three signals, F, V, and H, which are expected to be such that H has a falling edge at the start of every video line, and V has a falling edge at the start of every video field, F is intended to be high during the odd fields and low during the even ones. If there is a genlock input attached to the device, and the device is in a master mode (described later), then a signal from a synch separator 8, here LMH1981 sync separator, may take this from an external device and feed this directly into the clock module 2. If no genlock input is connected to the device, then the devise is in a slave mode (described later) and these signals are then synthesized by a Sync Pulser module 18.

The Sync Pulser module 18 is designed to operate alongside a Variable Local Clock (VLC) 16 module. These two modules both take a frequency control signal controlled by one of the registers settable in the EMBus module 20 (in the form of a 32-bit unsigned integer), and can both be reset to a specified value by setting other registers. The Sync Pulser 18 receives a line number and a number of nanoseconds through the line in order to be set, whilst the variable local clock 16 requires a number of seconds, frames, and sub-frame nanoseconds. In all cases these are specified assuming a 50 Hz European refresh rate (but may be modified if a 60/1.001 Hz American refresh rate is to be used).

The variable local clock 16 and Sync Pulser 18 will be initially set to values which correspond to each other according to the following relationship:

At midnight GMT on the 1st of January 1970 (Gregorian Calendar) line 1 of the first field of a frame started, and since that point lines have occurred once every 64 microseconds, fields have changed once every 312.5 lines, and new frames have started once every 2 fields.

If the two modules are set to comply with this relationship, then the relationship will be maintained regardless of how much the frequency control value is altered. The frequency control value is a 32-bit unsigned integer specified such that the variable local clock 16 counter will gain a number of nanoseconds equal to the frequency control value every 228 cycles of a received nominally 125 MHz ethernet clock, with the addition of these nanoseconds evenly distributed across this period. As such a value of 0x80000000 in the frequency control variable will ensure that the VLC counts at the same rate as the Fixed Local Clock (FLC), a second and nanosecond counter which runs off the ethernet clock and adds 8 ns every tick.

Regardless of which method is used to drive the Clock module 2 it generates its media clock outputs and also a top-of-frame pulse which indicates the start of frames. A Phase-lock-loop Counter (PLL Counter) 22 is a nanoseconds, frames, and seconds counter which runs from the generated 27 MHz video clock, and so when the Sync Pulser 18 is being used to drive the clock module it should in general maintain the same frequency as the variable local clock, however near the time when the frequency of the variable local clock changes there may be some delay in the response of the analogue PLL 22 in the clock module, and so the PLL Counter 22 would fall out of phase with the variable local clock counter. To avoid this, the PLL Counter 22 can be set to update its current time value once per frame so that it matches the variable local clock at that point, and this is the mode of operation normally used when the Sync Pulser is being used to drive the clock module.

When the clock module 2 is driven from the Sync Separator 8 then the stagebox device is running with a Genlock input. In such circumstances it is highly likely that there is also a Linear Time Code (LTC) input to the box, and so the PLL Counter may be set to adjust its time of day to match the LTC input once per frame.

The black and burst generator 4 also takes its synchronisation from the clock module 2 and the PLL Counter 20, and so will either generate a time-shifted version of the original genlock input (if running with a genlock input) or a black and burst output which has the frequency and phase specified for the Sync Pulser 18 (if the Sync Pulser is being used).

Finally, the PLL Counter 20 is used to drive three slave counters which are kept in phase with it. One is a PTP seconds and nanoseconds counter used to generate PTP timestamps for outgoing packets, the second is a 32-bit counter which always obeys the following relationship with the PLL Counter:

$$RT {P}_{90} = [ ( \frac{( ( {PLL}_{ns} + {PLL}_{s} \times {10}^{9} ) mod {2}^{64} ) \times 9}{{10}^{5}} ) mod {2}^{32} ] + RT {P}_{90}^{′}$$

where RTP′₉₀ is a 32-bit value which can be set in a register controllable from the processor board.

In practice that means that this counter is a nominal 90 kHz 32-bit counter as required for the video profile of RTP. The third counter is another 32-bit counter which always obeys the following relationship with the PLL Counter:

$$RT {P}_{48} = [ ( \frac{( ( {PLL}_{ns} + {PLL}_{s} \times {10}^{9} ) mod {2}^{64} ) \times 3}{62500} ) mod {2}^{32} ] + \text{?}$$

$$\text{?} \text{indicates text missing or illegible when filed}$$

where RTP′ 48 is a 32-bit value which can be set in a register controllable from the processor board, this counter actually runs off the nominal 24.576 MHz (512 times the nominal 48 kHz audio sample rate) clock output from the clock module 2 and so is suitable for use when tagging audio data sampled using that clock.

These counter values are made available to the a processor 14, here referred to as a Stagebox Core, which performs packetisation of the RTP streams used to transmit the stagebox's payload data.

The device hardware described may have a number of local oscillators which are used for different purposes. The ones which matter for this disclosure are a 125 MHz crystal oscillator used to time ethernet packets, and the 27 MHz voltage controlled oscillator used for audio and video signals. As so far described the 27 MHz oscillator is managed by a hardware clock management chip, the LMH1983 clock module 2 which is used in many traditional video devices. This module serves several purposes, most notably including a phase-lock-loop (PLL) designed to match the frequency of the local oscillator to that of an incoming reference signal generated from an incoming genlock signal via a sync separator chip. In addition the LMH1983 chip also provides additional PLLs which multiply and divide the frequency of the 27 MHz oscillator giving a variety of clock output frequencies, all locked as multiples of the controllable frequency of the oscillator. In particular the clock module has the following outputs:
27 MHz video dock (1×F).
148.5 MHz SDI clock (5.5×F).
24.576 MHz audio clock (

$$\frac{8192}{9000}$$

×F, noruinally 512×48 kHz).
A “Top of Frame” signal, which goes high briefly to indicate the start of each video frame. (

$$\frac{1}{1080000}$$

×F when in 50 Hz mode, and aligned with the rising edge of the “F” pulse on the clock module's input)

These clocks may be used by the device's other functions as their reference frequencies, as such it is possible to ensure that the audio and video sampling and playback performed by the stagebox hardware will be at the same frequency as that of another device by ensuring that the frequency of the 27 MHz voltage controlled oscillator (here termed F) is the same between the two devices. Since the value of F is controlled by the input reference signals to the LMH1983 clock module controlling the clock is achieved by controlling these signals. In the example design these signals are not connected directly to the output of the LMH1981 sync separator. Instead they are connected to controllable outputs on a Virtex 6 field-programmable-gate-array (FPGA) on the board. The outputs of the LMH1981 are similarly connected to controllable inputs of the FPGA. As such it is possible for the signals to be routed directly through the FPGA from the LMH1981 synch separator to the LMH1983 clock module, but it is also possible for the LMH1983 input signals to be driven by another source generating an artificially constructed series of synchronisation pulses synthesised based on a mathematical model of the remote clock.

In order for the device to be able to synchronise clocks with a global sense of time it uses the PTPv2 protocol, which enables high precision clock synchronisation over a packet-switched network. The PTP protocol relies for its precision on the ability to timestamp network packets in hardware at point of reception and transmission. In the stagebox architecture all packets received by the box's 1000 Mb/s ethernet interface are processed through the working of an SFP module 12, then passed back to the Xilinx Tri-Mode Ethernet MAC core 10 via the 1000-baseX PCS/PMA protocol. The Tri-Mode Ethernet Mac then passes these packets to the other components via an AXI-Steam interface.

Since some of these packets will be video and audio which the stagebox will need to decode in hardware all packets are passed to a core processor, here shown as Stagebox Core 14 for filtering, processing, and decoding. In addition all packets are also passed into a series of hardware block RAMs as part of the FIFO and Packet Filter Block.

The values of the VLC, the FLC, and the PLL Counter are all sampled at the time that the first octet of the packet leaves the MAC 10 and these values are stored with the packet, ready to be passed back to the processor. Not all packets, however, are passed back to the processor, instead each packet is examined according to the following rules:
IF is_unicast(pkt.address) AND pkt.address≠self.address THEN DROP.
IF NOT is_broadcast(pkt.address) AND
   hash(pkt.address) [symbol] mcast_addr_hashes THEN DROP.
IF pkt.is_ip4 AND pkt.is_udp AND pkt.udp.dst_port>1024 AND pkt.udp.dst_port [symbol] port_whitelist THEN DROP.
ALLOW

where mcast_addr_hashes is a set of hash values of ethernet multicast addresses which can be set via the EMBus registers, and port_whitelist is similarly a list of udp port numbers. In practice the hash function is such that it generates only 64 different hashes, and the port whitelist can be set using bitmasks to allow for certain patterns to be allowed through. Currently no port filtering is performed on non-UDP-in-IPv4 traffic directed to the box, so it would be possible to perform a denial of service attack on a stagebox by coding it with large amounts of IPv6 or TCP traffic. In practice this is unlikely to happen unless done intentionally.

The functionality of the timing processor 24 will now be described in more detail. The timing processor receives packets from the FIFO 26 via incoming bus line 7 and sends packets to the FIFO via outgoing bus line 9, connected via the EMBus 20.

On the transmit side there are three streams of packets which are switched together before being handed to the MAC for transmission. One is the stream of hardware generated packets emerging from the Stagebox Core 14, the second is the stream of software generated packets passed in via the EMBus 20, and the third is a second stream passed in via the EMBus 20. This last stream will only store one packet at a time prior to transmission, and records the values of the FLC, the VLC, and the PLL Counter at the time at which the first octet of the packet enters the MAC. These values are then conveyed back to the processor board via the EMBus. The software implementing the timing processor 24 may choose to mark a specific packet as requiring a hardware transmission time stamp. That packet is then sent preferentially (with higher priority than either the hardware or other software generated packets) and the timestamp is returned and made available to the software.

The hardware timestamping of certain received and transmitted packets is a feature provided to implement a PTP stack in the timing processor 24. The fact that multiple timestamps off different counters are generated allows a more complex algorithm for clock reconstruction. The use of packet filtering is important because the EMBus has only limited bandwidth (approximately 150 Mb/s when running continuously with no overhead, in practice often less than this) and the RTP streams generated by other AV streaming devices on the same network (such as other stageboxes) would swamp this connection very quickly if all sent to the processor.

The PTP stack implemented by the timing processor 24 on the stagebox is not maintained purely in hardware, rather hardware timestamping and clock control are managed by a software daemon executing on the timing processor 24 which operates the actual PTP state machine. The PTP daemon can operate in two different modes: Master-only, and Best-master mode.

The best-master mode is automatically triggered whenever the device detects that it does not have a valid 50 Hz black and burst signal on the genlock input port on the board. When in Best-Master mode the software implementing the timing processor 24 will advertise itself as a PTP Master to the network 5, but will defer to other masters and switch to the SLAVE state as described in the PTP specification if it receives messages from another clock which comes higher in the rankings of the PTP Best Master Algorithm. In all cases when acting as a master the software instructs the hardware to use the incoming reference from the Sync Separator 8 to run the Clock Module 2, and does not control the VLC at all, if there is no reference from the sync separator then this results in the 27 MHz oscillator free-running. When acting as a slave the hardware instead uses the Sync Pulser 18 as the source of synchronisation signals for the LMH1983 Clock Module 2 and the VLC as the source of timing values for the PLL, and the software in the timing processor 24 steers the oscillator by controlling the frequency control of the Sync Pulser 18 and VLC 16.

When advertising itself as a master the stagebox provides the following information in its PTP Announce messages:
Priority1 is set to 248
clockClass is set to 13 if there is a valid 50 Hz black and burst genlock input, and 248 otherwise.
clockAccuracy is set to 0x2C if there is a valid 50 Hz black and burst genlock input and a valid linear timecode input, and 0xFE otherwise.
offsetScaledLogVariance is currently set to −4000, though a future implementation may measure this in hardware.
Priority2 is set to 248
ClockIdentity is set to an EUI-64 derived from the ethernet MAC address of the stagebox treated as an EUI-48 rather than a MAC-48.
timeSource is set to 0x90 if there is a valid 50 Hz black and burst genlock input, and 0xA0 otherwise.

this ensures that stageboxes will, for preference, use non-stagebox masters (since most masters are set with a Priority1 value of less than 248), will favour stageboxes with a genlock input over those without, and will favour those with an LTC input over those without. A tie is broken by the value of the stagebox's MAC address, which is essentially arbitrary.

The actual synchronisation of the clocks is achieved via the exchange of packets described in the PTP specification. Specifically this implementation uses the IPv4 encapsulation of PTPv2, and acts as a two-step end-to-end ordinary clock capable of operating in both master and slave states.

The master implementation is relatively simple, using the PLL Counter in the hardware as the source for timestamps on both the transmitted and received packets. Since this counter is driven from the 27 MHz oscillator, and is set based on incoming linear time-code this means that the master essentially distributes a PTP clock which is driven from the incoming genlock for phase alignment, and the incoming LTC for time of day, or runs freely from system start up time. In either case since no date information is being conveyed to the box by any means the master defaults to the 1st of January 1970, with the startup time treated as midnight if there is no LTC input to provide time of day information.

The slave implementation is more complex. Incoming packets are timestamped using the VLC 16 and FLC (not shown) as well as the PLL Counter 22, and these values are used in the steering of the clock. In particular in order to acquire a fast and accurate frequency lock it is important to be able to determine the frequency of the remote clock relative to a local timebase which does not change when the frequency of the clock module is steered. For this purpose the FLC is used.

Incoming Sync packets received by the daemon in the timing processor in the slave state originating from its master are processed and their Remote Clock (RC) timestamp is stored along with the FLC and VLC timestamps for their time of reception. The FLC/RC timestamp pairs are filtered to discard erroneous measurements: in particular packets which have been delayed in a switch before being transmitted on to the slave will have an FLC timestamp which is higher than one would expect given their RC (transmission) timestamp and the apparent frequency of the clock based on the other measurements. These packets are marked as bad (though their value is retained as future data may indicate that they were not in fact bad packets) and ignored when performing further statistical analysis triggered by the receipt of this particular Sync packet. The further analysis takes the form of a Least-Mean-Squares (LMS) regression on the data, which is a simple statistical tool used to generate a line of best-fit from data with non-systematic error. The LMS regression requires a level of precision in arithmetic which is beyond the capabilities of the 64-bit arithmetic primitives provided by the operating system and processor, for that reason the daemon contains its own limited implementation of 128-bit integer arithmetic.

The LMS regression attempts to construct the gradient of the line of best fit for the graph of FLC timestamp vs. RC timestamp, which is to say the difference in frequency between the remote clock on the master (a multiple of the 27 MHz voltage controlled oscillator if the master is another stagebox) and a multiple of the ethernet clock on the local device (chosen because it is unaffected by the local oscillator steering, and because timestamps applied using this clock can be extremely accurate due to it being the same clock used for the actual transmit and receive architecture). To do so it selects the line which minimises the mean of the square of the difference between the line of best fit and the actual RC value at each FLC measurement. This difference in frequency can then be programmed into the VLC and Sync Pulser to match the frequency of the local oscillator to that of the remote clock.

In tests performed using just this portion of the control algorithm the error in frequency between the two clocks was extremely low, often in the range of parts per hundred million. This level of precision was good enough to be able to measure the change in frequency of both local and remote clocks as the temperature of the board changes. In order to accurately measure the error between the VLC and RC it is important to have an accurate measurement of the end-to-end network delay between the master and slave. This is measured using the End-to-End mechanism provided in PTPv2, in which an exchange of packets initiated by the slave is used to measure round-trip delays, and then the delay is assumed to be symmetric. The results of this algorithm are filtered in the following manner:

$$f [ n ] = ( s [ n ] - 1 ) \times F [ n - 1 ] + \frac{D [ n ] + D [ n - 1 ]}{2}$$

where F[n] is the nₜₕ filtered value, and D[n] is the nₜₕ raw delay measurement, and s[n] is a filter stiffness value which is such that:

$$s [ n ] = \{ \begin{matrix}1 & if n = 0 \\ MIN ( s [ n - 1 ] + 1 , {s}_{max} ) & otherwise\end{matrix}$$

where sₘₐₓ

is calculated based on a configurable parameter (usually 64), and also restricted to ensure, that the filtered value doesn't end up overowing the 32-bit arithmetic used to calculated it.

The value of D[−1] is set to be equal to D[0] to avoid a discontinuity in the filter at 0.

With the LMS correctly measured the local oscillator and the remote master are now closely locked in frequency, but there is no guarantee of phase-matching. To correct for this a second control loop was added which has a more traditional Phase-Lock-Loop design with a Proportional-Integral (PI) Controller driven from a measurement of the offset between the VLC and the RC.

Since network delays, and particularly delays caused by residence time in switches, can cause the apparent journey time for a packet to increase but never decrease the measured offset between the VLC and RC timestamps for each packet is filtered via a simple minimum operation, ensuring that the offset measurement from which. the PI-Controller works is always the floor of the recently measured (possibly errored) offset values. This filtered value is then fed into a standard PI-Controller and used to set a “correction value” which can be added to the calculated frequency to drive the counters slowly back into agreement. To prevent this change from altering the frequency too rapidly a series of moderating elements were added to ensure that the frequency of the oscillator would never be adjusted fast enough to cause a camera to which the device is attached to lose genlock when driven from the black-and-burst output of the stagebox device.

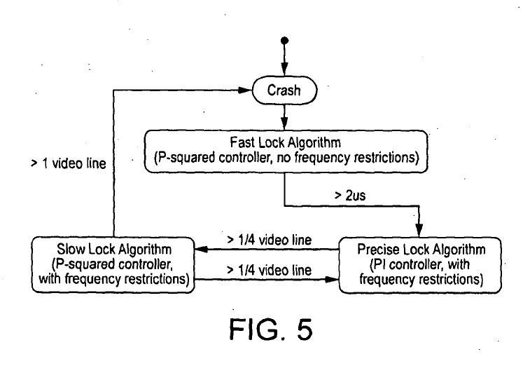

As is normal this PI-Controller has multiple different control regimes which it hands off between depending upon the behaviour of the filtered offset value, the state machine for this is shown in FIG. 5. As currently implemented immediately after the frequency measurement is applied the offset is then adjusted by “crashing” the VLC/Sync Pulser to a particular time which is calculated to give zero offset. This rarely produces exactly zero offset, but is usually within one video line. Control is then handed over to the “Fast-lock” algorithm, which actually adjusts frequency proportionally to the square of the P term and ignores the integral term; the fast-lock also has no frequency restrictions to prevent it from disrupting the genlock signal to a camera.

Once the counters are within a few microseconds of each other (which is usually the case within a few seconds of the process starting) the daemon then hands control over to the “Precise lock” algorithm, which is the traditional PI controller with frequency change restrictions. If the error ever reaches more than one quarter of a line of video then control is passed over to the “Stow Lock” algorithm, which is a P2 controller with change restrictions, and when the error falls back below the one quarter of a line threshold the “Precise Lock” is invoked again. Only if the error reaches more than one line of video is another “crash” triggered and the “Fast Lock” algorithm reinvoked. The gains of the various control regimes are scaled so that the control value is smooth across all these boundaries with the exception of the “crash lock” which triggers a full reset of all control values. In this way we are able to achieve a lock-time in the order of 5-20 seconds once the daemon has been started depending upon network conditions and how close the frequencies of the clocks were to begin with.

The stagebox software build will, at start up, search for a DHCP server on the local network, and use an IPv4 address provided by one if there is one. If no address can be acquired, via DHCP it falls back to automatic configuration of a link-local address. It also automatically configures IPv6 addresses in the same way, but these are not currently used. This behaviour ensures that stageboxes can operate correctly even if the only devices on the network are a number of stageboxes connected to switches. It even allows the stageboxes to operate correctly when connected using a point-to-point network cable between two boxes.

The design contains a Stagebox Core which can generate two streams of RTP packets, a video stream and an audio stream which contains raw 24-bit PCM audio. These packets also contain RIP header extensions in compliance with specifications for RTP streams for IP Studio. The hardware generating these streams requires certain parameters (such as source and destination addresses, ports, payload types, and ttl values) to be set in the registers made available to the processor, and also generates certain counters which report back data required in order to generate the accompanying RTCP packets to go with the streams.

1. Apparatus for converting between synchronous audio, video and control signals and asynchronous packaged data streams for an IP network, comprising:
a first interface for audio and video signals;
a second interface for control signals; and
a processor arranged to convert between synchronous audio, video and control signals and asynchronous packaged data streams, wherein each packaged data stream is according one of multiple IP standards, each standard being selected according to the nature of the signal to be transmitted.

2. Apparatus according to claim 1, wherein the device is arranged to select the standard that is the lowest bandwidth such standard for the selected signal.

3. Apparatus according to claim 1, wherein a lower bandwidth protocol is used for the control signals than the audio video signals.

4. Apparatus according to claim 1, wherein the audio and video are converted RTP.

5. Apparatus according to claim 1, wherein the control signals are converted to UDP or TCP.

6. (canceled)

7. Apparatus according to claim 1, wherein the apparatus includes a processor for receiving control signals in an IP standard and for asserting a control output at a camera.

8. Apparatus according to claim 7, wherein the control output is a tally visual or audio indicator.

9. Apparatus according to claim 1, wherein the control output is a camera control signal, such as RS232, RS422, LANG.

10. Apparatus according to claim 1, wherein the control output is preferably a talkback signal, namely a bidirectional audio feed between camera operator and a controller.

11. Apparatus according to claim 1, wherein the apparatus comprises an input arranged to receive the multiple IP video streams over the IP network from other camera sources and a processor arranged to output video for presentation to a camera operator.

12. Apparatus according to claim 1, wherein the apparatus comprises a device connectable to a video camera having connections to the interfaces, in the form of a separate box with attachment to the camera.

13. Apparatus according to claim 12, wherein the processor is arranged to convert from native audio-video signals of the camera to asynchronous packaged data streams for transmission to studio equipment.

14. Apparatus according to claim 12, wherein the processor is arranged to convert control signals from asynchronous packaged data streams received from studio equipment to native signalling required by the camera or by ancillary devices coupled to the camera.

15. Apparatus according to claim 1, wherein the apparatus comprises a device connectable to studio equipment.

16. Apparatus according to claim 15, wherein the processor is arranged to convert from asynchronous packaged data streams received from cameras to native audio-video signals required by the studio equipment.

17. Apparatus according to claim 15, wherein the processor is also arranged to convert control signals from the studio equipment to asynchronous packaged data streams for transmission to one or more cameras.

18. Apparatus according to claim 1, further comprising timing functionality arranged to control a local clock in the device relative to timestamps from other devices received over IP.

19. Apparatus according to claim 18, wherein the timing functionality comprises filtering received timestamps from received packets and controlling the local clock based on the filtered timestamps.

20. Apparatus according to claim 19, wherein the filtering comprises discarding packets from the timing process for which the received timestamp is outside a time bound.

21. Apparatus according to claim 18, wherein the timing functionality uses PTP protocol to timestamp network packets in hardware at point of reception and transmission.

22. Apparatus according to claim 18, wherein the timing functionality comprises controlling the frequency control of the local clock using the received timestamps.

23. Apparatus according to claim 22, wherein the timing functionality comprises stamping received packets on receipt with a local timestamp derived from a local clock, passing the received packets to a best fit algorithm and producing a best fit between local timestamps and timestamps within the packets from a remote source.

24. Apparatus according to claim 23, wherein the best fit comprises Least-Mean-Squares (LMS) regression.

25. Apparatus according to claim 18, wherein the timing functionality further comprises controlling the phase control of the local clock using the received timestamps.

26. Apparatus according to claim 25, wherein a measured offset between a local clock and received clock timestamp for each packet is filtered using a minimum operation.

27. A method for converting between synchronous audio, video and control signals and asynchronous packaged data streams for an IP network, comprising:
receiving audio and video signals;
receiving control signals; and
converting between synchronous audio, video and control signals and asynchronous packaged data streams, wherein each packaged data stream is according one of multiple IP standards, each standard being selected according to the nature of the signal to be transmitted.

28. A system comprising multiple cameras and studio equipment, each camera and the studio equipment having apparatus for converting between synchronous audio, video and control signals and asynchronous packaged data streams for an IP network, comprising:
a first interface for audio and video signals;
a second interface for control signals; and
a processor arranged to convert between synchronous audio, video and control signals and asynchronous packaged data streams, wherein each packaged data stream is according one of multiple IP standards, each standard being selected according to the nature of the signal to be transmitted.

29. (canceled)

30. (canceled)
